(19) United States
(12) Patent Application Publication
(10) Pub. No.: US 2009/0319326 A1
(43) Pub. Date: Dec. 24, 2009

(54) CONTINUING PROFESSIONAL DEVELOPMENT SYSTEM FOR INDUSTRIAL HUMAN RESOURCES

(75) Inventor: Tomoho YAMADA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: TOMS CORPORATION, Tokyo (JP)

(21) Appl. No.: 12/494,466

(22) Filed: Jun. 30, 2009

Related U.S. Application Data
(63) Continuation of application No. PCT/JP2008/053736, filed on Mar. 3, 2008.

(30) Foreign Application Priority Data
Feb. 6, 2008 (JP) 2008-044626

(51) Int. Cl. G06Q 10/00; G06F 17/30; G06N 5/02

(52) U.S. Cl. 705/8; 707/5; 706/52; 707/E17.017; 707/E17.044

(57) ABSTRACT

An environment is constructed in which students, job seekers, and employees can surely improve their skills to become the human resource image having skills and the like required by enterprises and industrial human resources can continuously receive education throughout their lifetime.

The present invention includes a human resource management database server device, a skill database server device, an application server device, and a Web server device. The human resource management database device includes a learning record information table, a personal basic information table, and a personal evaluation information table according to learning. The skill database server device includes a required knowledge information table in which information for acquiring required skills is recorded, a taken course result information table in which information on achievement level evaluations for contents of a taken course is recorded, and a course information table. A learning record search means is capable of transmitting learning record information retrieved from the learning record information table in response to a search request for learning record information from a terminal.

### CROSS-REFERENCE TO RELATED APPLICATIONS

This is a continuation of PCT International Application No. PCT/JP2008/53736, filed Mar. 3, 2008, which claims the benefit of Japanese Patent Application No. 2008-044626, filed Feb. 6, 2008, the entire disclosure of each of which are incorporated herein by reference.

### BACKGROUND OF THE INVENTION

1. Field of the Invention

The present invention relates to a continuing professional development system for industrial human resources, and more particularly belongs to the technical field of continuing professional development systems for industrial human resources for constructing an environment in which industrial human resources can continuously receive education throughout their lifetime with the aim of becoming a human resource sought by enterprises and the society.

2. Description of the Related Art

In recent years, as rapid changes in social structure and diversification of values accompanying computerization and globalization has been advancing, increases in precision, reliability, and speed of technologies have been sought. Under such circumstances, despite the fact that the human resource image and values sought by enterprises and the society have been changing, there have emerged mismatches in employment and working environments.

Against the foregoing background, Japanese Patent Application Laid-Open Publication No. 2002-133048, for example, discloses a human resource management system in which prospective employee information, which is information on persons in an informal appointment period of getting employed to a temporary-employment agency, temporary employee information, which is information on persons who are employees of the temporary-employment agency and registered as temporary employees, and post-retirement information, which is information on persons who have been the temporary employees in the past, are stored in a human resource management server, the human resource management server allowing the status of persons who have been the temporary employees to be grasped by updating the post-retirement information even after the persons have ceased to be the employees.

### Patent Document 1: Japanese Patent Application Laid-Open Publication No. 2002-133048 (Claim 1)

However, the databases handled by the human resource management system of Patent Document 1 include basic human resource information, such as name, sex, and date of birth, information on fundamental abilities, information on education/training progress, and the like of registrants who desire to become temporary employees but does not cover detailed skill data of registrants which employing companies want to know. Moreover, the human resource management system of Patent Document 1 does not provide information for registrants to improve their own skills and cannot appropriately match industrial human resources with the human resource image and values sought by hiring enterprises in terms of the increases in precision, reliability, and speed of technologies in recent years described above.

That is, an environment for continuously developing and supporting industrial human resources throughout their lifetime has not been established, and therefore it is impossible to sufficiently perform evaluation of industrial human resources who can play in international competitions as “individuals.” Therefore, a need exists for indicators and guidelines for acquiring skills required for career formation.

Accordingly, an object of the present invention is to provide a continuing professional development system for industrial human resources for establishing an environment in which industrial human resources (students, workers, and the like) leading the innovation of Japan can continuously receive education throughout their lifetime, thereby creating a mechanism of continuing professional development of engineers through a social frame, in order to achieve consistent improvement of qualities of industrial human resources and consequently improvement of industrial competitiveness of Japan, and for constructing an environment in which students, job seekers, and employees can surely improve their skills to become the human resource image having skills and the like required by enterprises.

### SUMMARY OF THE INVENTION

As a means for solving the above problems, a continuing professional development system for industrial human resources according to a first aspect of the invention is a computer system relating to continuing professional development of industrial human resources P which is capable of connecting to the Internet 1 in response to a query from a terminal 7, including: a human resource management database server device 2 for recording and managing a database on personal information of industrial human resources P; a skill database server device 3 for recording and managing a database on skills of industrial human resources P; an application server device 4 for performing management work of a learning record; and a Web server device 5 connecting to the Internet 1, wherein the human resource management database device 2 includes a learning record information table 20 in which a learning record is recorded, a personal basic information table 21 in which personal basic information is recorded, and a personal evaluation information table 22 in which a personal evaluation according to learning is recorded; the skill database server device 3 includes a required knowledge information table 30 in which information for acquiring required skills is recorded, a taken course result information table 31 in which information on achievement level evaluations for contents of a taken course is recorded, and a course information table 32 in which systematized course information is recorded; the application server device 4 includes a learning management means 40 and a learning record search means 41; the learning management means 40 accepts transmission of evaluation information in response to a storage request for evaluation information for a learning unit from a terminal 7, and is capable of recording an achievement level according to a learning level of an industrial human resource P, composed of systematized required knowledge items stored in the required knowledge information table 30 and information in a personal basic information table 21 and a learning record information table 20 of the industrial human resource P, into the personal evaluation information table 22 and the taken course result information table 31; the learning record search means 41 is capable of transmitting learning record information R retrieved from the learning record information table 20, in combination with contents of the personal evaluation information table 22, in response to a search request for learning record information R from a terminal 7.

In a continuing professional development system for industrial human resources according to a second aspect of the invention, the required knowledge information table 30 has recorded therein, for each level, an course roadmap, which is an course model for acquiring skills for each profession, specialized field, major, or academic year, contents of the course roadmap being displayed in a matrix format M in response to a query from a terminal 7.

In a continuing professional development system for industrial human resources according to a third aspect of the invention, the application server device 4 includes a behavior prediction transmission means 42 capable of transmitting behavior prediction information, which has been obtained by combining and modeling information from the required knowledge information table 30, the course information table 32, and the taken course result information table 31, in response to a search request for a behavior prediction from a terminal 7.

A continuing professional development system for industrial human resources according a fourth aspect of the invention is configured so that the human resource management database device 2 and the skill database server device 3 are accessible after identity is confirmed by means of a contact-type IC card 60, a non-contact-type IC card 61, a USB connection-type IC card 62, or an IC chip-incorporated mobile phone 72 upon a query at the terminal 7.

In a continuing professional development system for industrial human resources according to a fifth aspect of the invention, the terminal 7 includes personal computers 70, mobile terminals 71, mobile phones 72, and gaming devices 73.

In a continuing professional development system for industrial human resources according to a sixth aspect of the invention, information recorded and managed in the human resource management database server device 2 and the skill database server device 3 from the terminal 7 is always up-to-date information.

The continuing professional development system for industrial human resources according to the first aspect of the present invention includes: a human resource management database server device for recording and managing a database on personal information of industrial human resources; a skill database server device for recording and managing a database on skills of industrial human resources; an application server device for performing management work of a learning record; and a Web server device connecting to the Internet, and the human resource management database device includes a learning record information table in which a learning record is recorded, a personal basic information table in which personal basic information is recorded, and a personal evaluation information table in which a personal evaluation according to learning is recorded; the skill database server device includes a required knowledge information table in which information for acquiring required skills is recorded, a taken course result information table in which information on achievement level evaluations for contents of a taken course is recorded, and a course information table in which systematized course information is recorded; the application server device includes a learning management means and a learning record search means; the learning management means accepts transmission of evaluation information in response to a storage request for evaluation information for a learning unit from a terminal, and is capable of recording an achievement level according to a learning level of an industrial human resource, composed of systematized required knowledge items stored in the required knowledge information table and information in a personal basic information table and a learning record information table of the industrial human resource, into the personal evaluation information table and the taken course result information table; the learning record search means is capable of transmitting learning record information retrieved from the learning record information table, in combination with contents of the personal evaluation information table, in response to a search request for learning record information from a terminal.

Accordingly, students and workers who are job seekers can easily grasp their own current skills by accessing and querying the database server device from a terminal and searching and querying for managed learning record information, and can grasp required skills, take measures such as participating in courses, and surely improve their skills to match the human resource image required by the enterprise side.

Moreover, the enterprise side of personnel representatives can find and match persons who meet industrial human resources whom they seek by accessing and querying the database server device from a terminal and querying for learning record information and the like, whereby a great contribution to improvement of qualities and industrial competitiveness of industrial human resources is achieved. In other words, an environment in which industrial human resources can continuously receive education throughout their lifetime with the aim of becoming a human resource sought by enterprises and the society is realized, and a mechanism of continuing professional development of engineers through a social frame is constructed.

Moreover, by using the continuing professional development system for industrial human resources, educational institutions can achieve enhancement of job hunting support, and course-providing companies can promote improvement of quality of courses and lecturers.

In the continuing professional development system for industrial human resources according to the second aspect of the present invention, the required knowledge information table has recorded therein, for each level, an course roadmap, which is an course model for acquiring skills for each profession, specialized field, major, or academic year, contents of the course roadmap being displayed in a matrix format in response to a query from a terminal. Therefore, students/workers using the present system can easily grasp skill levels required for themselves at a glance and rationally make a learning plan for achieving their goals.

In the continuing professional development system for industrial human resources according to the third aspect of the invention, the application server device includes a behavior prediction transmission means capable of transmitting behavior prediction information, which has been obtained by combining and modeling information from the required knowledge information table, the course information table, and the taken course result information table, in response to a search request for a behavior prediction from a terminal. Therefore, it is possible to access the present system by using various types of terminals, display a proposal of items to be learned on a display according to a desired annual income or occupation, and perform simulations of the professions/annual incomes and the like for which the user is qualified.

The continuing professional development system for industrial human resources according the fourth aspect of the invention is configured so that the human resource management database device and the skill database server device are accessible after identity is confirmed by means of a contact-type IC card, a non-contact-type IC card, a USB connection-type IC card, or an IC chip-incorporated mobile phone upon a query at the terminal. Therefore, these contact-type, non-contact, and USB connection-type IC cards and IC chip-incorporated mobile phones function as so-called security keys, thereby ensuring that malicious falsification, leakage, or the like of the present data including personal information is prevented.

In the continuing professional development system for industrial human resources according to the fifth aspect of the invention, the terminal includes personal computers, mobile terminals, mobile phones, and gaming devices. Therefore, there is great convenience in that students/workers, enterprises, schools, and the like can easily access the present system anywhere at any time by using these various types of terminals.

Moreover, it is possible to access the present system by using gaming devices, upload data (learning, occupation, and annual income) regarding outcomes (success and failure) which the user has experienced, play games, and perform information exchange between individuals through chatting and the like.

In the continuing professional development system for industrial human resources according to the sixth aspect of the invention, information recorded and managed in the human resource management database server device and the skill database server device from the terminal is always up-to-date information. Therefore, students/workers, enterprises/educational institutions, and the like accessing the present system can always obtain up-to-date information mutually, skills can be surely improved to become the human resource image having skills and the like required by enterprises, and rational and continuing education based on up-to-date and accurate information is realized.

### BRIEF DESCRIPTION OF THE DRAWINGS

FIG. 1 is an explanatory diagram including a configuration block diagram of a continuing professional development system for industrial human resources according to the present invention;

FIG. 2 is an explanatory diagram showing one embodiment of input data for a human resource management database server device and a skill database server device;

FIG. 3 is an explanatory diagram showing a main menu screen of the present continuing professional development system;

FIG. 4 is an explanatory diagram showing one embodiment of a course record screen of the present continuing professional development system;

FIG. 5 is an explanatory diagram showing one embodiment of a different course record screen of the present continuing professional development system;

FIG. 6 is an explanatory diagram showing one embodiment of a different course record screen of the present continuing professional development system;

FIG. 7 is an explanatory diagram showing one embodiment of a career information screen of the present continuing professional development system;

FIG. 8 is an explanatory diagram showing one embodiment of a skill matrix screen of the present continuing professional development system;

FIG. 9 is an explanatory diagram showing one embodiment of a reference of the course information screen of the present continuing professional development system;

FIG. 10 is a workflow diagram showing an initial registration process of the present continuing professional development system;

FIG. 11 is a workflow diagram showing a registration process of course information of the present continuing professional development system;

FIG. 12 is a workflow diagram showing how to make a learning plan of the present continuing professional development system;

FIG. 13 is a workflow diagram showing a confirmation process of a course participation result/achievement level evaluation of the present continuing professional development system; and

FIG. 14A is a workflow diagram showing a search process for a human resource of the present continuing professional development system, and FIG. 14B is a workflow diagram showing an information provision process of the same.

### DESCRIPTION OF THE PREFERRED EMBODIMENTS

Preferred embodiments of the continuing professional development system for industrial human resources according to the present invention will be described below in accordance with the drawings. Embodiments according to first to sixth aspects of the invention are common and therefore will be collectively described as below.

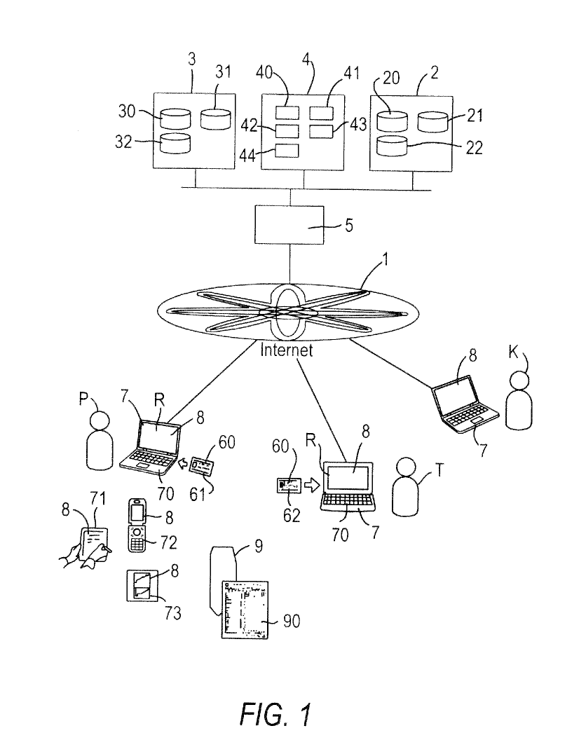

FIG. 1 shows a basic configuration of a continuing professional development system for industrial human resources according to the present invention. This continuing professional development system is a computer system relating to continuing professional development of industrial human resources P which is capable of connecting to the Internet 1 in response to a query from a terminal 7.

In a preferred embodiment, identity is confirmed by means of a contact-type IC card 60, a non-contact-type IC card 61, a USB connection-type IC card 62, a non-contact IC chip-incorporated mobile phone 72, or the like upon a query at the terminal 7. That is, the human resource management database device 2 and the skill database server device 3 described below are accessible after the IC card 60, 61, or 62 (or the IC chip-incorporated mobile phone 72) readable by the terminal 7 is connected to the terminal 7, a password, an ID code, or the like is input, and identity is confirmed. Examples of the terminal 7 broadly include personal computers 70, as well as mobile terminals 71, mobile phones 72, and gaming devices 73. The terminal 7 is provided with a display 8.

As shown in FIG. 1, the basic configuration of the present system includes functional blocks of a human resource management database server device 2 for recording and managing a database on personal information of industrial human resources P, such as students and workers; a skill database server device 3 for recording and managing a database on skills of the industrial human resources P; an application server device 4 for performing management work of learning records; and a Web server device 5 including a firewall connecting to the Internet 1. These functional blocks are composed of a combination of hardware and software and are realized by a combination of elements such as a CPU of a computer as hardware and a program having a data processing function as software.

The human resource management database device 2 includes a learning record information table 20 in which a learning record of a student or worker P, who is an industrial human resource, is recorded; a personal basic information table 21 in which personal basic information is recorded; and a personal evaluation information table 22 in which a personal evaluation according to learning is recorded. A name, an address, an academic record, a job record, and the like are recorded in the personal basic information table 21, and an evaluation of academic record, an evaluation of job record, an evaluation of business type, an evaluation of qualification, and the like are recorded in the personal evaluation information table 22.

Moreover, the skill database server device 3 includes a required knowledge information table 30 in which an course model for acquiring required skills is recorded for each level; a taken course result information table 31 in which information on achievement level evaluations for contents of a taken course is recorded; and a course information table 32 in which systematized course information is recorded. In the course information table 32, detail information of courses, as well as implementation information, test information, provider information, and the like are recorded.

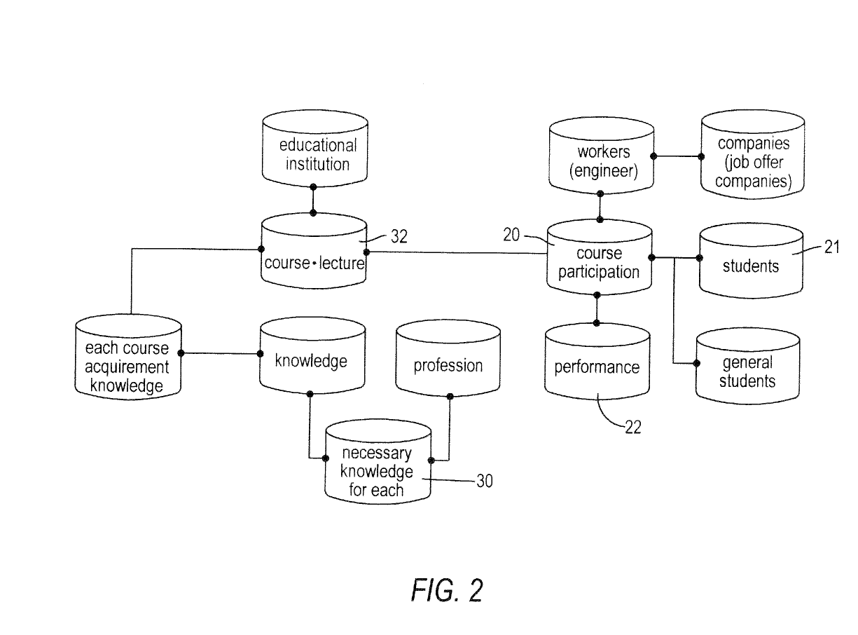

Meanwhile, as sources of information to be input to the tables of the human resource management database device 2 and the skill database server device 3 described above, information on “enterprise,” “student” (21), “course participation” (20), “score” (22), “course/lecture” (32), “knowledge,” “required knowledge by profession” (30), and the like as shown in FIG. 2 is input through the terminal 7.

Next, the application server device 4 includes a learning management means 40, a learning record search means 41, a behavior prediction transmission means 42, a user registration means 43, and a course information transmission means 44. The user registration means 43 performs user registration into the personal basic information table 21 in response to a signal of a use application request from a terminal 7 made by a student or worker P, who is an industrial human resource. Moreover, the course information transmission means 44 reads out and transmits course information required for the student/worker P or the like from course information recorded in the course information table 32, on the basis of information recorded in the personal basic information table 21, in response to a search request for course information from a terminal 7.

The learning management means 40 accepts transmission of evaluation information in response to a storage request for evaluation information for a learning unit from a terminal 7 and records an achievement level according to a learning level of the industrial human resource P, composed of systematized required knowledge items stored in the required knowledge information table 30 and information in the personal basic information table 21 and the learning record information table 20 of the industrial human resource P, into the personal evaluation information table 22 and the taken course result information table 31.

Further, the learning record search means 41 is configured to read out and transmit learning record information R retrieved from the learning record information table 20, in combination with contents of the personal evaluation information table 22 of the industrial human resource P, in response to a search request for learning record information R from a terminal 7.

The behavior prediction transmission means 42 reads out and transmits behavior prediction information, which has been obtained by combining and modeling information from the required knowledge information table 30, the taken course result information table 31, the course information table 32, the personal basic information table 21, and the personal evaluation information table 22, in response to a search request for a behavior prediction from a terminal 7.

Meanwhile, data recorded and managed as described above are always recorded and managed in the human resource management database server device 2 and the skill database server device 3 as up-to-date data.

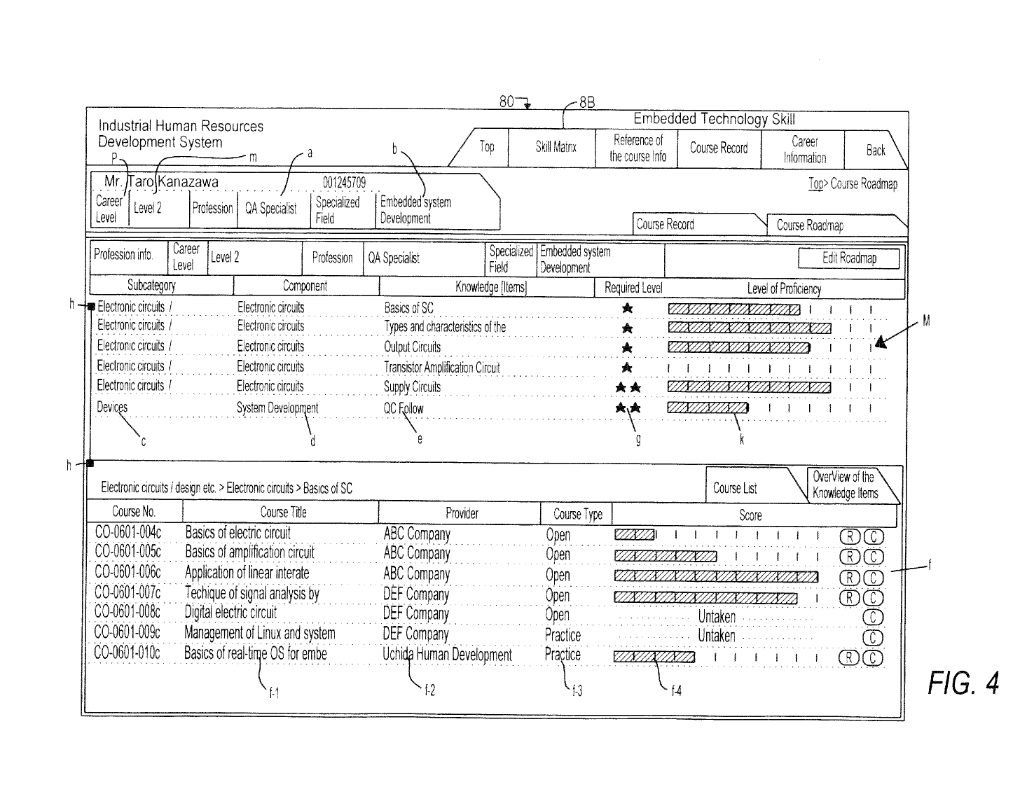

Further, the required knowledge information table 30 has recorded therein, for each level, an course roadmap, which is an course model for acquiring skills for each profession, specialized field, major, or academic year, and contents of the course roadmap can be displayed on a display 8 connected to a terminal 7 in a matrix format in response to a query from the terminal 7 (see FIGS. 4, 5, and 8).

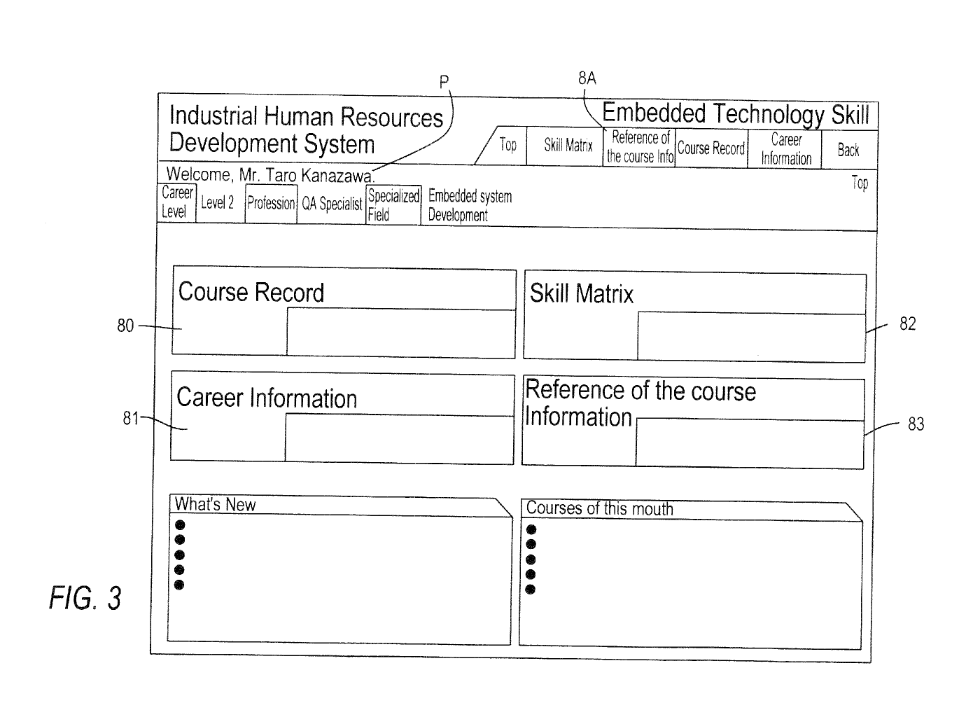

Hereinbelow, a method by which a student P displays a learning record and the like and performs searches and browsing, by operating a terminal 7, in the continuing professional development system for industrial human resources described above will be described by use of operation result screens displayed on a display 8 (FIGS. 3 to 9). Meanwhile, operation result screens of a personnel representative (educational institution) T are also embodied in a similar manner, but will be described later.

A student P connects an IC card 60 (61, 62) (sometimes referred to as a “learning record card”) to a terminal 7, starts a WWW browser, connects to the Internet 1, and accesses a website of the present system on which “Industrial Human Resources Development System” is displayed. On an unshown login screen, the student P obtains a previously registered ID (described later). Then, a main menu screen 8A shown in FIG. 3 is displayed.

On the main menu screen 8A of FIG. 3, four items, that is, “Course Record” 80, “Career Information” 81, “Skill Matrix” 82, and “Reference Of The Course Information” 83 of “Mr. Taro Kanazawa” (tentative), who is the student P (industrial human resource), are selectably displayed.

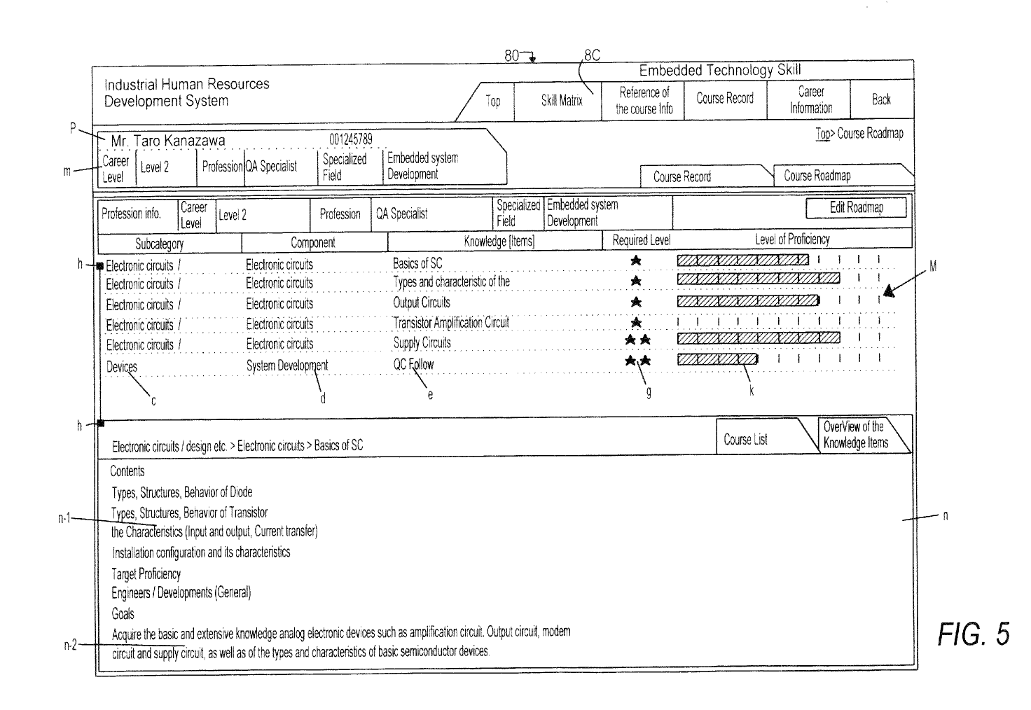

Upon selecting “Course Record” 80 on the main menu screen 8A of FIG. 3, a display screen 8B of FIG. 4 is displayed, whereby the student P can grasp his own current skills. That is, under the current status in which a career level m is set to “Level 2,” knowledge items e to be learned according to subcategories c and components d of a profession a (“QA Specialist” in the shown example) and a specialized field b (“Embedded System Development” in the shown example) are automatically displayed together with a course list f and a knowledge item outline n (see FIG. 5) in a lower department. Moreover, since required levels g of the student P are indicated by the number of stars and levels of proficiency k are graphically indicated by percentages, the student P can simply and quickly grasp his own current skills. Therefore, it is possible to confirm the “weaknesses and strengths” specific to the individual student P at a glance, confirm the gap between his own current skills and required skills from the information, and make a learning plan for achieving an objective.

The course list f displayed in a lower area of FIG. 4 is a list of courses related to the item indicated by the reference character h selected in the example shown in the upper area of the figure, that is, the knowledge item e in the case where the subcategory c is “Electronic Circuit/Design, etc.,” the component d is “Electronic Circuit,” and the knowledge item e is “Basics of Semiconductor.” In the course list f, course titles f−1, providers f−2, course types f−3, course participation results f−4 indicated by percentages, and the like are displayed, whereby the student P can grasp his own weak points to be reinforced. Further, by selecting an item of a desired course from this course list f, it is possible to apply for a desired course on a course application screen (not shown).

Moreover, in a lower department of a display screen 8C shown in FIG. 5, an outline of the knowledge item e of the item indicated by the reference character h can be ascertained. For example, contents of the knowledge item e of the relevant item h, such as “Intrinsic semiconductors and impurity semiconductors” indicated by the reference character n−1 and “Operation and characteristics of basic semiconductor elements. Moreover, amplifier circuits, oscillation circuits, . . . ” indicated by the reference character n−2, are displayed in detail.

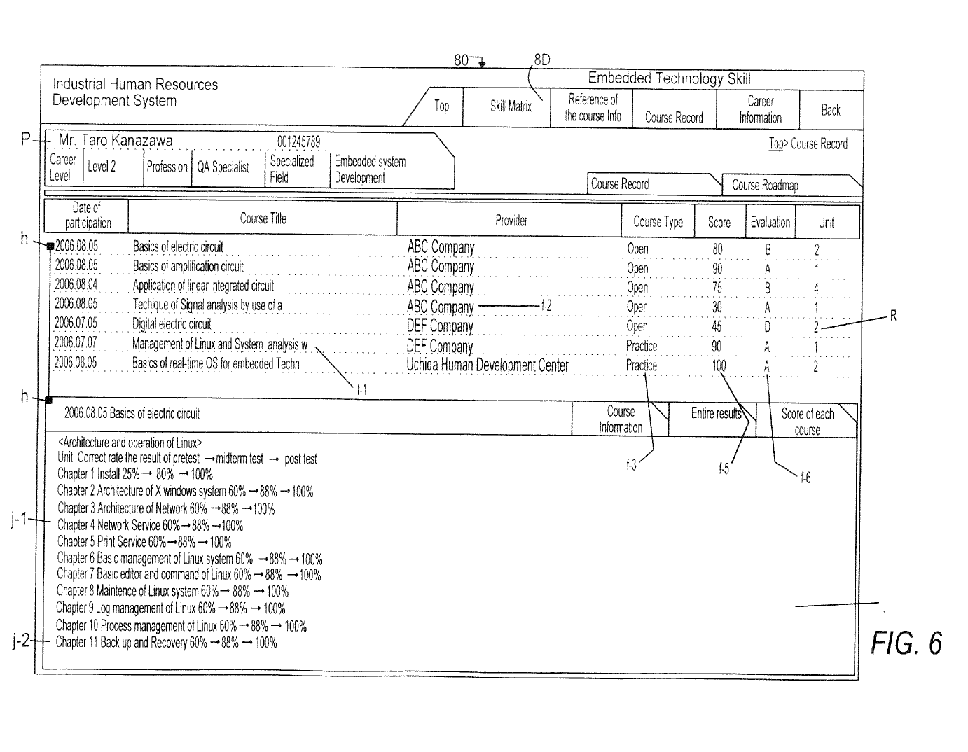

Further, by means of a display screen 8D shown in FIG. 6, the student P can confirm his own learning record R. That is, course participation dates (year/month/day), course titles f−1, providers f−2, course participation types f−3, scores f−5 indicated by points, and evaluations f−6 indicated by A, B, C or D of courses in which he has previously participated can be confirmed for each course. Further, by means of “Score by Chapter” j in a lower department of FIG. 6, it is possible to ascertain the learning record in further detail. In the lower department of the figure, scores by chapter in the course of “Basics of Electronic Circuits” f−1 indicated by the reference character h displayed in the upper department are indicated by percentages of correct-answer rate at each of the three stages: pre-test score, in-course test score, and post-test score. For example, “Chapter 4. Network Services 60% →88% →100%” as indicated by the reference character j−1 and “Chapter 11. Backup and Recovery 60% →88% →>100%” as indicated by the reference character j−2 are displayed, whereby it is possible to properly make a learning plan.

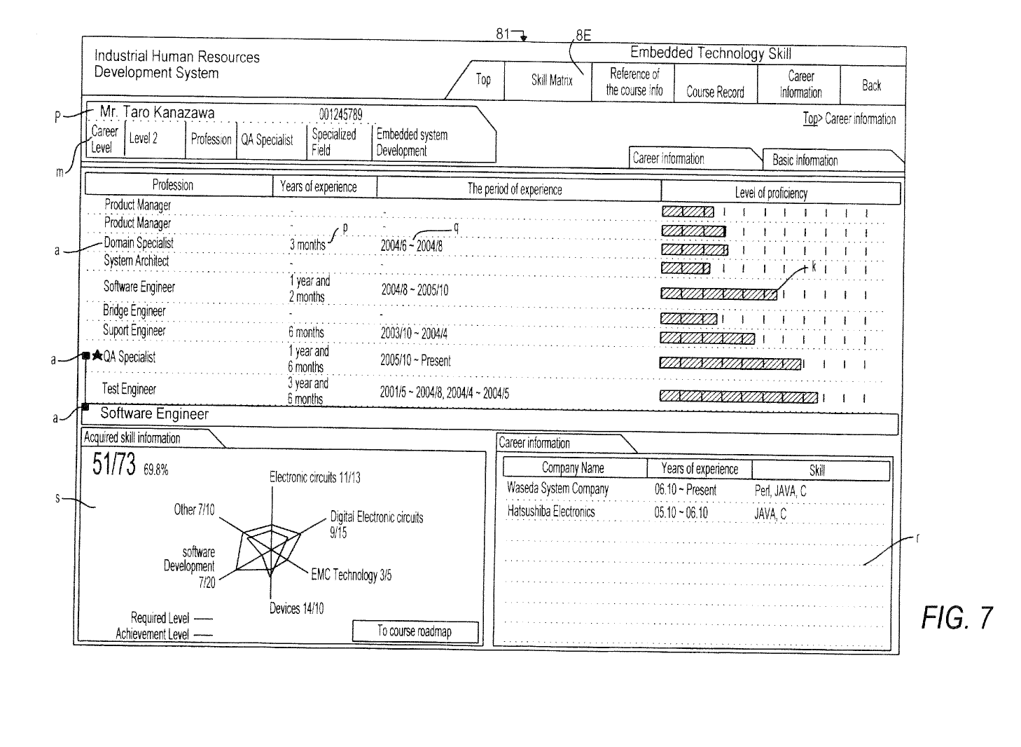

FIG. 7 shows one display screen 8E which is displayed as a result of selecting “Career Information” 81 on the display screen 8A of FIG. 3. Professions a of each business type are displayed with graphs showing levels of proficiency k. For each profession a, a number of years of experience p, a period of experience q, and a level of proficiency k are shown in an upper department, taken course skill information s is shown in a left area of a lower department, and career information r is shown in a right area of the lower department. In the taken course skill information s of the shown example, skill information in a case where the skill a in the upper department is “QA Specialist” a is indicated by numerical values and the like as achievement level values for required level values. In career information r, contents of employer company name, number of years of experience, and skill are shown as a career, in the case of “QA Specialist” again, whereby the student P can confirm experience for each business type and can also confirm which professions a he is qualified or not.

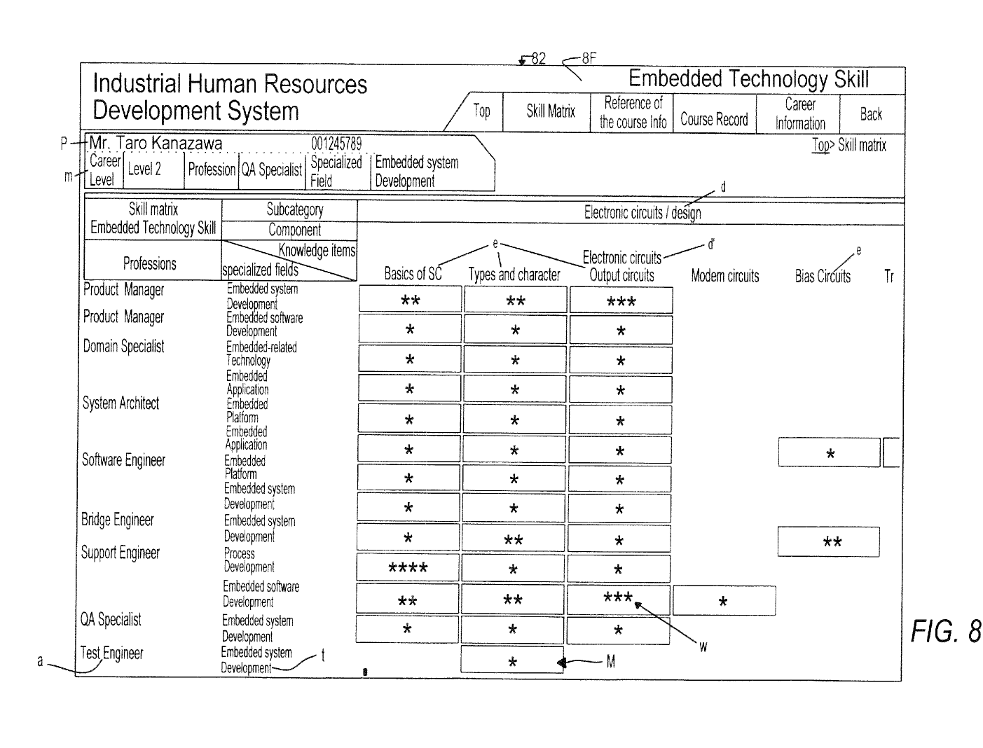

FIG. 8 shows one display screen 8F of a “Skill Matrix” which is displayed as a result of selecting the item “Skill Matrix” 82 on the display screen 8A of FIG. 3. In this “Skill Matrix,” since professions a are displayed along a vertical axis, knowledge items e are displayed along a horizontal axis, and required skill levels are each indicated by the number of stars w, it is possible to confirm required knowledge items e for each targeted profession at a glance. Specifically, the figure presents a skill matrix in which a component d is “Electronic Circuit” and a subcategory d′ is “Electronic Circuit/Design.” Further, importance levels of knowledge items e corresponding to professions a and specialized fields t are indicated by stars w.

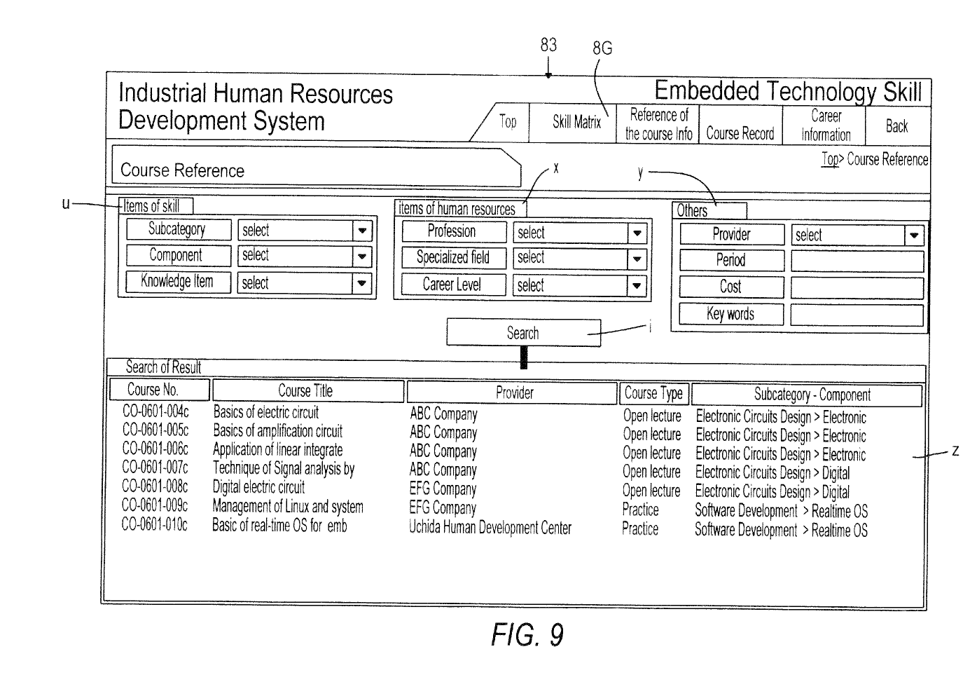

FIG. 9 shows one display screen 8G which is displayed as a result of selecting “Reference Of The Course Information” 83 on the display screen 8A of FIG. 3. After selecting each of the search contents of “Subcategory,” “Component,” and “Knowledge Item” under “Skill Item” u, selecting each of the search contents of “Profession,” “Specialized Field,” and “Career Level” under “Human Resource Item,” and selecting search contents of “Provider” and the like under “Others” y, the item “Search” i in a middle area is selected for performing a search. Then, search result information z composed of a list table of course information as shown in a lower department of the figure is displayed. Accordingly, the student P can surely find the most suitable course for himself from the course information shown in this search result information z, apart from course application from the course list f displayed as shown in FIG. 4. Further, by applying for a required course on an unshown relevant course application screen and actually participating in the course, it is possible to efficiently fill a skill gap. Moreover, information after course participation is reflected in learning record information R (see FIGS. 4 and 6), whereby the student P can confirm the learning achievement level for each course.

Next, operation screens for a human resources representative (enterprise) T will be described (not shown). In this case, “Career Information” 81 in the operation screens for the student P is provided as “Sectoral Information.” As the sectoral information, an average level of proficiency for each department is indicated by a percentage and a level of proficiency of an individual employee (P) is also indicated by a percentage, and therefore it is possible to accurately ascertain individual levels of proficiency. In the screen 8E of career information shown in FIG. 7, since all professions a for each business type are displayed with graphs showing levels of proficiency k, it is possible to confirm the career of the individual employee (P) for subject work at a glance. In this manner, the human resources representative T can confirm achievement levels of learners for each course and required industrial human resources P. Further, the human resources representative T can search for industrial human resources P for each profession and for each knowledge item by means of a skill matrix by using the present system.

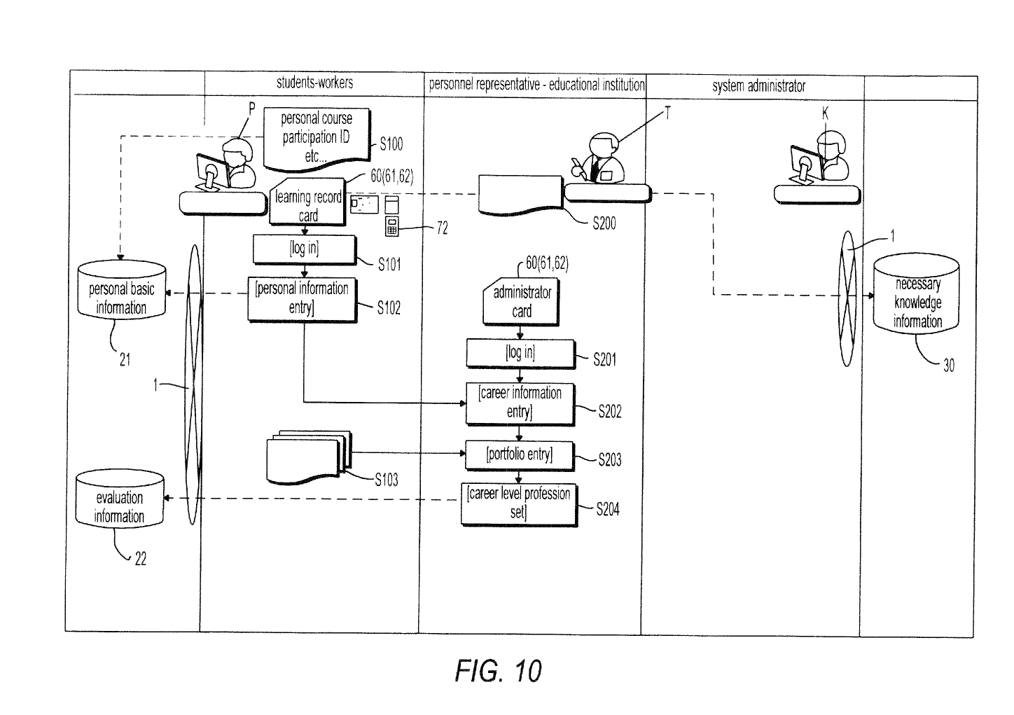

Next, a flow of work of continuing professional development of industrial human resources according to the present invention will be described on the basis of workflow diagrams shown in FIGS. 10 to 14.

FIG. 10 shows an initial registration process.

### <Student/Worker>

First, a student or worker, who is an industrial human resource P, registers an obtained personal course participation ID and the like into the personal basic information table 21 of the human resource management database server device 2 of the present system by using a terminal 7 (S100).

Here, a course participant who participates in a course is taken as an example. In order for a student P, who is the course participant, to access the present system, the student P starts the present continuing professional development system for industrial human resources at a terminal 7, undergoes personal authentication by means of a contact-type IC card 60 (or a non-contact-type IC card 60 or a USB connection-type IC card 62) or an IC chip-incorporated mobile telephone 72 at the terminal 7, and then logs in to the present system (S101). Meanwhile, the various types of IC cards 60 and the like are also referred to as “learning record cards” as described above because they can also record learning records by means of the present system.

When a screen for registering personal information appears, registration is performed by inputting a profile (S102). The profile is registered as data into the personal basic information table 21 of the human resource management database server device 2 and is also provided for career information registration at step 202 described below. Moreover, information (S103) obtained as a result of answering to a questionnaire on already acquired knowledge and skills is provided for “Portfolio Registration” at step 203 described below.

### <Personnel Representative/Educational Institution>

A personnel representative of an enterprise or an educational institution T previously accesses the present system and registers the information of the “Skill Matrix” described above into the required knowledge information table 32 of the skill database server device 3 as step 200 (S200).

A personnel representative T, who is an evaluator, starts the present system at a terminal 7, undergoes personal authentication by means of any of the various types of IC cards 60 (60, 62) and the like, which are “administrator cards,” at the terminal 7, and then logs in to the present system (S201). Upon logging in, items of “Career Information Registration” based on the information of the profile which the student P has input as personal information appear, at which skills of the student P are evaluated and the skill evaluations are registered as data (S202). Moreover, portfolio registration is performed on the basis of questionnaire results of the student P (S203), and then career level profession setting is performed (S204). The data of the career level setting is reflected in the personal evaluation information table 22.

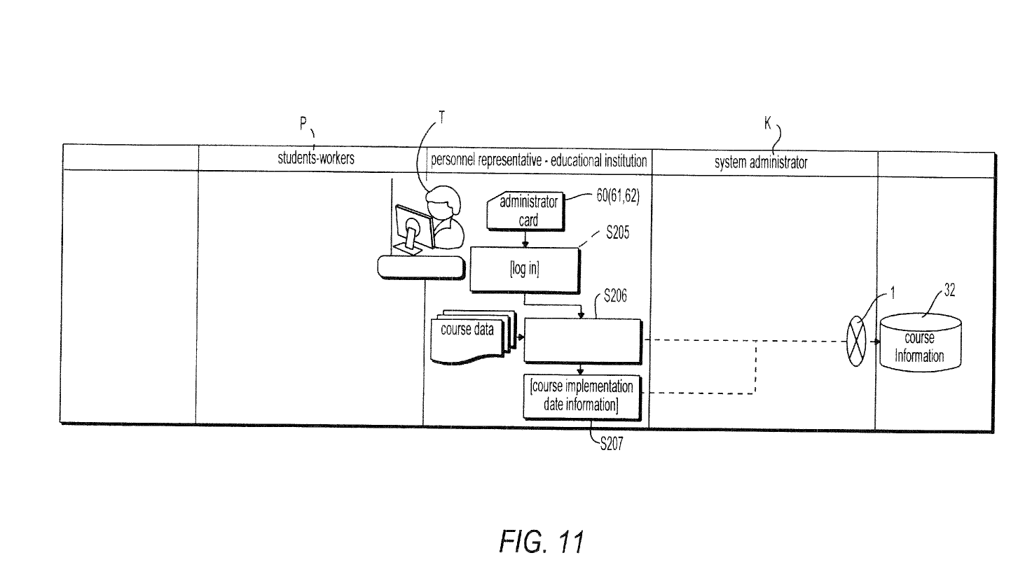

FIG. 11 shows a registration process of course information.

### <Personnel Representative/Educational Institution>

An educational institution T, which is a course provider, starts the present system at a terminal 7, as described above, undergoes personal authentication by means of an administrator card 60 (61, 61) which is any of various types of IC cards, and then logs in to the present system (S205). At step 206, information on lecturers, knowledge which can be acquired, and the like are registered as data into the course information table 32 of the skill database server device 3 as detailed information on courses, on the basis of course data (S206). Moreover, information such as dates on which courses are implemented is also registered into the course information table 32 (S207).

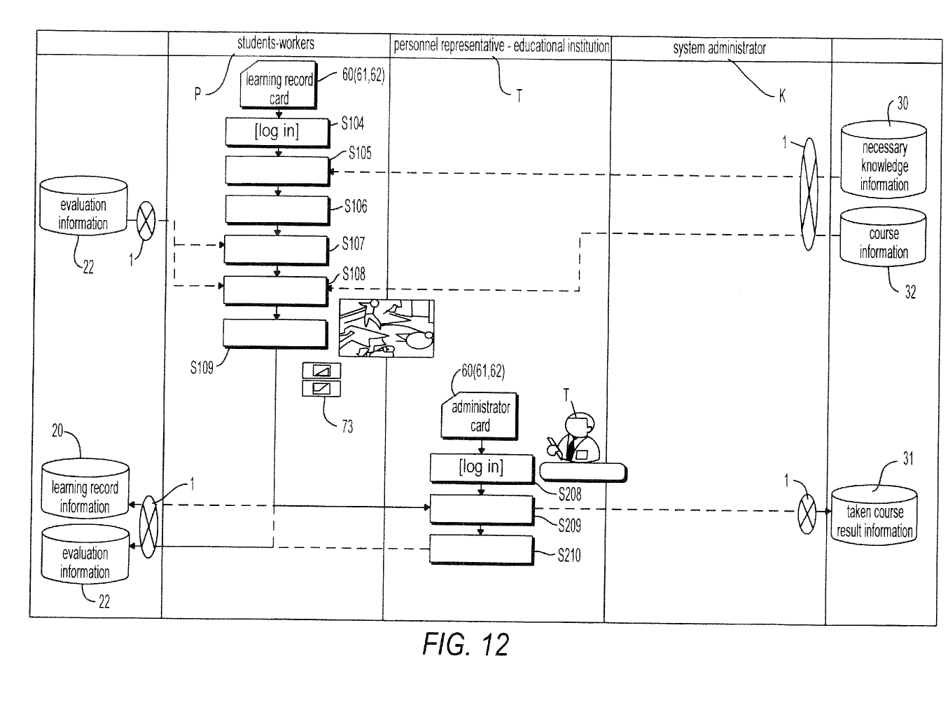

FIG. 12 shows how to make a learning plan, and an input process of a portfolio.

### <Student/Worker>

A student/worker P, who has logged in by undergoing personal authentication by means of a learning record card 60 (61, 61) which is any of various types of IC cards (S104), confirms items to be learned on the basis of data provided from the required knowledge information table 30 at step 105. That is, the student/worker P selects a targeted profession or knowledge by means of the skill matrix (S105). At the subsequent step 106, levels of proficiency of skills for each knowledge item are displayed on an course roadmap screen, whereby current skill levels are confirmed (S106).

Then, the student/worker P confirms the knowledge which he/she lacks from a level of proficiency graph displayed from the personal evaluation information table 24 and the like (S107) and searches for a course which supplements the knowledge which he/she lacks (S108). The course information is provided from the course information table 32. Course information can be also viewed by means of gaming devices 73 and the like, and the student/worker P participates in a desired course selected from the course information (S109). Results of course participation are recorded in the personal evaluation information table 22, reflected in the learning record information table 20, and registered into a portfolio of a personnel representative (educational institution) T described below (S209).

### <Personnel Representative/Educational Institution>

A personnel representative/educational institution T, who is an evaluator and has logged in by undergoing personal authentication by means of an administrator card 60 (61, 61) (S208), is given information on the courses in which the student/worker P has participated from the learning record information table 20. When the personnel representative/educational institution T performs portfolio registration (S209), the data is registered as data into the taken course result information table 31. Moreover, at step 210, the personnel representative/educational institution T performs career level setting (S210), and the information is registered as data into the personal evaluation information table 22.

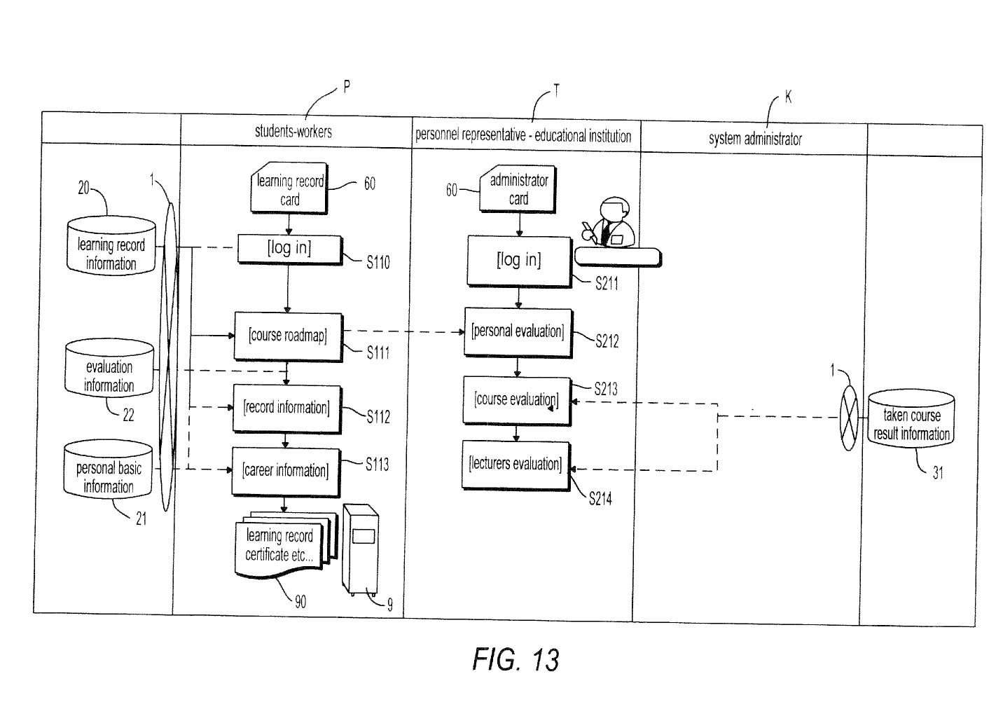

FIG. 13 shows a confirmation process of a course participation result/achievement level evaluation.

### <Student/Worker>

A student/worker P, who has logged in by undergoing personal authentication by means of a learning record card 60 (61, 61) (S110), confirms a level of proficiency for each knowledge unit on a screen of an course roadmap on the basis of data of the learning record information table 20, the personal evaluation information table 22, and the personal job record table 21 at step 111 (S111). The student/worker P confirms course participation results on a screen of study information at step 112 (S112) and confirms current career evaluations on a screen of career information at step 113 (S113). Further, when required, the student/worker P issues the confirmed personal data as a learning record certificate 90 or the like by means of a certificate issuing device 9. The certificate issuing device 9 can access the continuing professional development system for industrial human resources via the Internet 1, issues various types of certificates 90 and the like on the basis of the learning record information table 20 recorded and managed in the human resource management database device 2, and can be installed at school premises, stores, and the like.

### <Personnel Representative/Educational Institution>

A personnel representative T, who has logged in by undergoing personal authentication by means of an administrator card 60 (61, 61) (S211), confirms achievement levels of course participants (students P and the like) on a screen of personal evaluations, for which data is transmitted from the learning record information table 20, the personal evaluation information table 22, and the personal job record table 21 (S212), and confirms outcomes for each course on a screen of course evaluations (S213). Moreover, at step 214, the personnel representative T confirms achievement levels for each lecturer on a screen of lecturer evaluations. Specifically, they are score information, reflection of research outcomes in skill standards, optimization of courses, utilization of a lecturer human resource inside and outside a school, enhancement of job hunting supports, evaluation of teachers, and the like. Data accumulated in the taken course result information table 31 is reflected in the lecturer evaluations and the foregoing course evaluations.

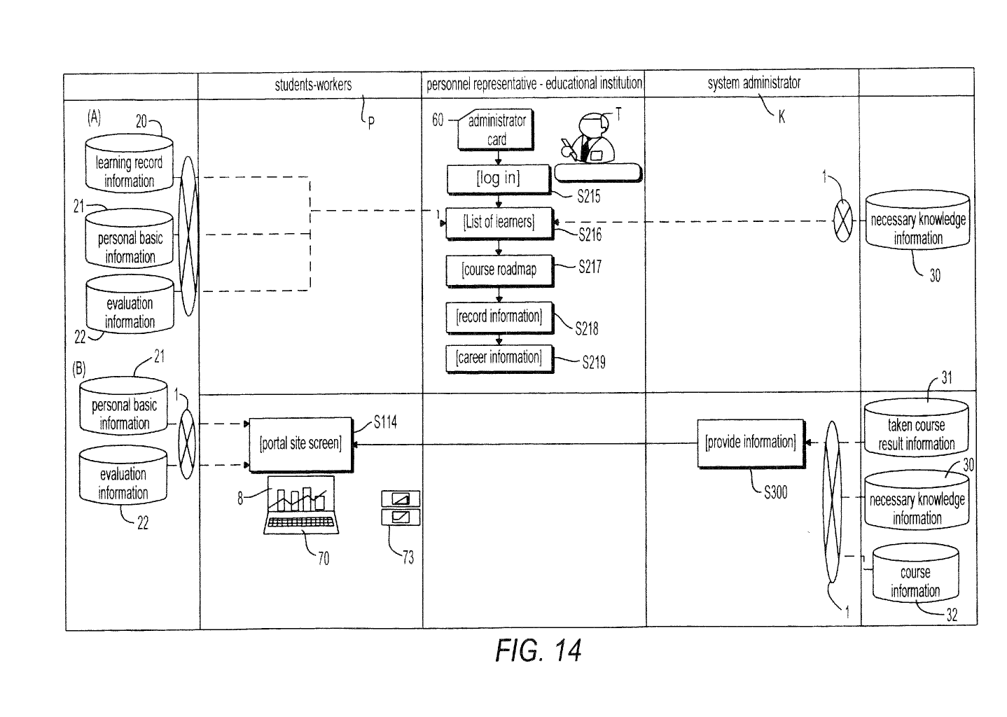

FIG. 14 shows a search process (A) for human resources and an information provision process (B). First, the search process of FIG. 14A will be described.

### <Personnel Representative/Educational Institution>

A personnel representative T, who has logged in by undergoing personal authentication by means of an administrator card 60 (61, 61) (S215), searches for human resources (industrial human resources P) on the basis of acquired knowledge of course participants and jobs for which course participants are qualified on a screen of a list of learners, for which data is transmitted from the learning record information table 20, the personal basic information table 21, the personal academic record table 22, and the required knowledge information table 30 (S216). Because searches can be accurately performed, it is easy to perform assessment of practical abilities of job applicants, whereby personnel rating based on proper assessment of practical abilities is promoted. Moreover, it is possible to present clear career plans to employees, whereby smooth and proper personnel rotations are achieved.

Next, the personnel representative T can confirm levels of proficiency for each knowledge unit of course participants on a screen of an course roadmap (S217), confirm course participation results on a screen of study information (S218), and further confirm current career evaluations on a screen of career information (S219).

The information provision process of FIG. 14B will be described. Information is provided as a simulation about an indicator or the like from accumulated information.

### <System Administrator>

A system administrator K performs data registration in order to provide learning methods for each profession, job offer information such as annual income, and the like on a screen of information provision from data accumulated in each of the required knowledge information table 30, the taken course result information table 31, and the course information table 32 of the skill database server device 3 (S300).

### <Student/Worker>

A student/worker P can access the present system by using a terminal such as a personal computer 70 or a gaming machine 73 and perform simulations of learning plans and the like appropriate for job offer information and annual incomes/desired occupations on a portal site screen, on which data of the information provision and data of the personal basic information table 21 and the personal evaluation information table 22 are reflected (S114).

The present invention allows accessing and querying a database server device from a terminal and searching and querying for managed learning record information, is suitable for realizing an environment in which industrial human resources can continuously receive education throughout their lifetime, and is applied to construction of a mechanism of a system for professional development of engineers.

What is claimed is:

1. A computer system relating to continuing professional development for industrial human resources which is capable of connecting to the Internet in response to a query from a terminal, comprising:
a human resource management database server device for recording and managing a database on personal information of industrial human resources;
a skill database server device for recording and managing a database on skills of industrial human resources;
an application server device for performing management work of a learning record; and
a Web server device connecting to the Internet, wherein
said human resource management database device includes: a learning record information table in which a learning record is recorded, a personal basic information table in which personal basic information is recorded, and a personal evaluation information table in which a personal evaluation according to learning is recorded;
said skill database server device includes: a required knowledge information table in which information for acquiring required skills is recorded, a taken course result information table in which information on achievement level evaluations for contents of a taken course is recorded, and a course information table in which systematized course information is recorded;
said application server device includes a learning management means and a learning record search means;
said learning management means accepts transmission of evaluation information in response to a storage request for evaluation information for a learning unit from a terminal, and is capable of recording an achievement level according to a learning level of an industrial human resource, composed of systematized required knowledge items stored in said required knowledge information table and information in a personal basic information table and a learning record information table of the industrial human resource, into said personal evaluation information table and said taken course result information table;
said learning record search means is capable of transmitting learning record information retrieved from said learning record information table, in combination with contents of said personal evaluation information table, in response to a search request for learning record information from a terminal;
said required knowledge information table has recorded therein, for each level, an course roadmap, which is an course model for acquiring skills for each profession, specialized field, major, or academic year, contents of the course roadmap being displayed in a matrix format in response to a query from a terminal;
said application server device includes a behavior prediction transmission means capable of transmitting behavior prediction information, which has been obtained by combining and modeling information from the required knowledge information table, the course information table, and the taken course result information table, in response to a search request for a behavior prediction from a terminal; and
the human resource management database device and the skill database server device are accessible after identity is confirmed by means of a contact-type IC card, a non-contact-type IC card, a USB connection-type IC card, or an IC chip-incorporated mobile phone upon a query at said terminal.

2. The continuing professional development system for industrial human resources according to claim 1, wherein the terminal includes personal computers, mobile terminals, mobile phones, and gaming devices.

3. The continuing professional development system for industrial human resources according to claim 1, wherein information recorded and managed in the human resource management database server device and the skill database server device from the terminal is always up-to-date information.

4. The continuing professional development system for industrial human resources according to claim 2, wherein information recorded and managed in the human resource management database server device and the skill database server device from the terminal is always up-to-date information.
